(19) United States
(12) Patent Application Publication
(10) Pub. No.: US 2017/0235211 A1
(43) Pub. Date: Aug. 17, 2017

(54) EQUIPMENT HOLSTER

(71) Applicant: Shai Eynav, Ithaca, NY (US)

(72) Inventor: Shai Eynav, Ithaca, NY (US)

(21) Appl. No.: 15/041,734

(22) Filed: Feb. 11, 2016

(51) Int. Cl. G03B 17/56; F16M 13/04; A45F 5/02

(52) U.S. Cl. CPC G03B 17/561; A45F 5/021; F16M 13/04; A45F 2005/025

(57) ABSTRACT

Embodiments of the invention provide a holster for coupling a camera to an article of clothing, for example, a belt, of a wearer. The holster comprises a camera engaging base plate coupled to a retaining subassembly via a coupling pin. The holster is configured to permit rotation of the camera with respect to the retaining subassembly.

### CROSS REFERENCE TO RELATED APPLICATIONS

The present application is a continuation-in-part of United States (U.S.) application Ser. No. 12/678,741 naming the same inventor and filed in the USPTO on 17 Mar. 2010, which is a US national phase application of PCT/US08/76878 naming the same inventor and filed in the PCT receiving office of the USPTO on 18 Sep. 2008, which claims priority to U.S. provisional application Ser. No. 60/973,424 naming the same inventor and filed in the USPTO on Sep. 18, 2007. This application claims the benefit of earlier filed U.S. provisional application Ser. No. 61/251,096 naming the same inventor and filed in the USPTO on Oct. 13, 2009. Each of the aforementioned applications is hereby incorporated by reference herein in its entirety.

### FIELD OF THE INVENTION

The invention provides a quick release holster for equipment carried about the body of a person. The holster allows equipment such as cameras, lens' and other tools and devices to be securely carried on a person's body without impeding movement of the arms and hands and without interfering with body positioning such as bending, sitting and kneeling. At the same time the equipment is quickly and easily released from the holster and available for use by the wearer.

### SUMMARY OF THE INVENTION

Embodiments of the invention provide a coupling for coupling a camera to an article of clothing, for example, a belt, of a wearer. The coupling devices comprise a slot engaging portion on one end for engaging a slotted receptacle of a support structure. The device includes a camera engaging portion on another end for engaging a thread receiving receptacle of a camera. The coupling piece is configured to permit rotation of the camera with respect to the support structure when the thread receiving receptacle of the camera is engaged with the camera engaging portion, and when the slot engaging portion is engaged with the slotted receptacle.

### DESCRIPTION OF THE DRAWING FIGURES

These and other objects, features and advantages of the invention will be apparent from a consideration of the following detailed description of the invention considered in conjunction with the drawing figures, in which:

FIG. 1 is an illustration of a camera detachably coupled to a wearer's belt using a coupling device according to an embodiment of the invention;

FIG. 2 is an illustration of a camera coupled to a wearer's belt as illustrated in FIG. 1 by a coupling device according to an embodiment of the invention wherein the camera is shown as it appears when swiveled about an axis of the coupling device with respect to the belt;

FIG. 3 is a top view of a coupling device according to an embodiment of the invention securing a camera and lens assembly to a wearer's belt wherein the camera and lens assembly is swiveled about an axis of the coupling device to accommodate a seated position of the wearer;

FIG. 4 is a top view of a coupling device according to an alternative embodiment of the invention securing a camera and lens assembly to a wearer's belt wherein the camera and lens assembly is swiveled about an axis of the coupling device to accommodate a seated position of the wearer;

FIG. 5 illustrates a second part of a coupling device according to an embodiment of the invention;

FIG. 6 is a perspective view of a first part of a coupling device configured in accordance with an embodiment of the invention;

FIG. 7 is a perspective view of a coupling device according to an embodiment of the invention illustrating a first part and a second part positioned for sliding engagement;

FIG. 8 is a top view of a first part attached to a camera according to an embodiment of the invention;

FIG. 9 is a front view of a second part of a coupling device configured in accordance with an embodiment of the invention;

FIG. 10 is a perspective view of a coupling device according to an embodiment of the invention illustrating a first part and a second part positioned for sliding engagement;

FIG. 11 is a front elevation view of a first part of a coupling device according to an embodiment of the invention;

FIG. 12 is a top view of the first part of the coupling device illustrated in FIG. 11 as seen when the first part is attached to a camera;

FIG. 13 is a rear elevation of a first part of a coupling device according to an embodiment of the invention;

FIG. 14 is a perspective view of a camera protecting part of a coupling device according to an embodiment of the invention;

FIG. 15 is a perspective view of a coupling device showing the first and second parts coupled together and in position for attachment of the camera protecting piece illustrated in FIG. 14;

FIG. 16 is a top view of the coupling device illustrated in FIG. 15 including the camera protection piece illustrated in FIG. 14;

FIG. 17 is a top view of a coupling device according to an alternative embodiment of the invention;

FIG. 18 illustrates an alternative embodiment of the invention;

FIG. 19 illustrates a coupling pin according to an embodiment of the invention;

FIG. 20 is a top view of a clip according to an embodiment of the invention;

FIG. 21 is a front elevation view of a clip according to an embodiment of the invention;

FIG. 22 is a front view of a clip according to an alternative embodiment of the invention;

FIG. 23 depicts a retainer and clip subassembly according to an embodiment of the invention;

FIG. 24 depicts a base subassembly of a camera assembly according to an embodiment of the invention;

FIG. 25 depicts a camera assembly including a retainer and clip subassembly engaging a base subassembly according to an embodiment of the invention;

FIG. 26 depicts an auxiliary clip for use with a camera carrying assembly according to an embodiment of the invention;

FIG. 27 depicts an auxiliary clip for use with a camera carrying assembly according to an embodiment of the invention;

FIG. 28 depicts engagement of a retainer and clip subassembly of an embodiment of the invention with the auxiliary clip;

FIG. 29 depicts engagement of a retainer and clip subassembly of an embodiment of the invention with an auxiliary clip;

FIG. 30 depicts a retainer and clip subassembly coupled to a base subassembly via a coupling pin according to an embodiment of the invention, the embodiment including a thumbwheel latch in a latched position;

FIG. 31 depicts a retainer and clip assembly engaged coupled to a base assembly via a coupling pin according to one embodiment of the invention, wherein a thumbwheel latch is shown in an unlatched position;

FIG. 32 illustrates a user's hands engaging first and second coupling pins of a base assembly of a camera carrying assembly according to an embodiment of the invention;

FIG. 33 illustrates a camera carrying assembly according to an embodiment of the invention including a coupling plate;

FIG. 34 illustrates a camera carrying assembly according to an embodiment of the invention including a coupling plate and illustrating attachment of the coupling plate to the base of the camera carrying assembly;

FIG. 35 illustrates the coupling plate of FIG. 10 engaging a coupling plate receptacle of a tripod according to an embodiment of the invention;

FIG. 36 illustrate the coupling plate of FIG. 10 engaging a coupling plate receptacle of a tripod according to an embodiment of the invention;

FIG. 37 illustrates steps for coupling a camera to a tripod by means of a coupling plate according to an embodiment of the invention;

FIG. 38 illustrates steps for coupling a camera to a tripod by means of a coupling plate according to an embodiment of the invention;

FIG. 39 illustrates steps for coupling a camera to a tripod by means of a coupling plate according to an embodiment of the invention;

FIG. 40 illustrates steps for coupling a camera to a tripod by means of a coupling plate according to an embodiment of the invention;

FIG. 41 illustrates steps for coupling a camera to a tripod by means of a coupling plate according to an embodiment of the invention;

FIG. 42 illustrates a photographer engaging and disengaging a camera from the photographer's belt using a camera carrying assembly according to an embodiment of the invention;

FIG. 43 illustrates a photographer engaging and disengaging a camera from the photographer's belt using a camera carrying assembly according to an embodiment of the invention;

FIG. 44 illustrates a rear surface of a base plate of a base subassembly of a camera carrying assembly according to an embodiment of the invention;

FIG. 45 illustrates a base subassembly of a camera carrying assembly according to an embodiment of the invention;

FIG. 46 illustrates a base subassembly of a camera carrying assembly according to an embodiment of the invention including an attaching tool;

FIG. 47 illustrates a base subassembly of a camera carrying assembly according to an embodiment of the invention including an attaching tool;

FIG. 48 illustrates a belt threaded through a clip of a retainer and clip subassembly of a camera carrying assembly according to an embodiment of the invention.

### DETAILED DESCRIPTION OF THE INVENTION

In accordance with the present invention, there is provided herein an apparatus for fastening a camera and lens assembly to a belt of a wearer. A coupling device according to embodiments of the invention permits a camera and lens assembly to be fastened securely to a wearer's belt while permitting a wearer to quickly and easily detach the camera and lens assembly from the belt. The fastening apparatus of the invention advantageously permits rotational motion of a camera and lens assembly relative to the belt to accommodate bending and seating positions of the belt wearer.

### FIG. 1

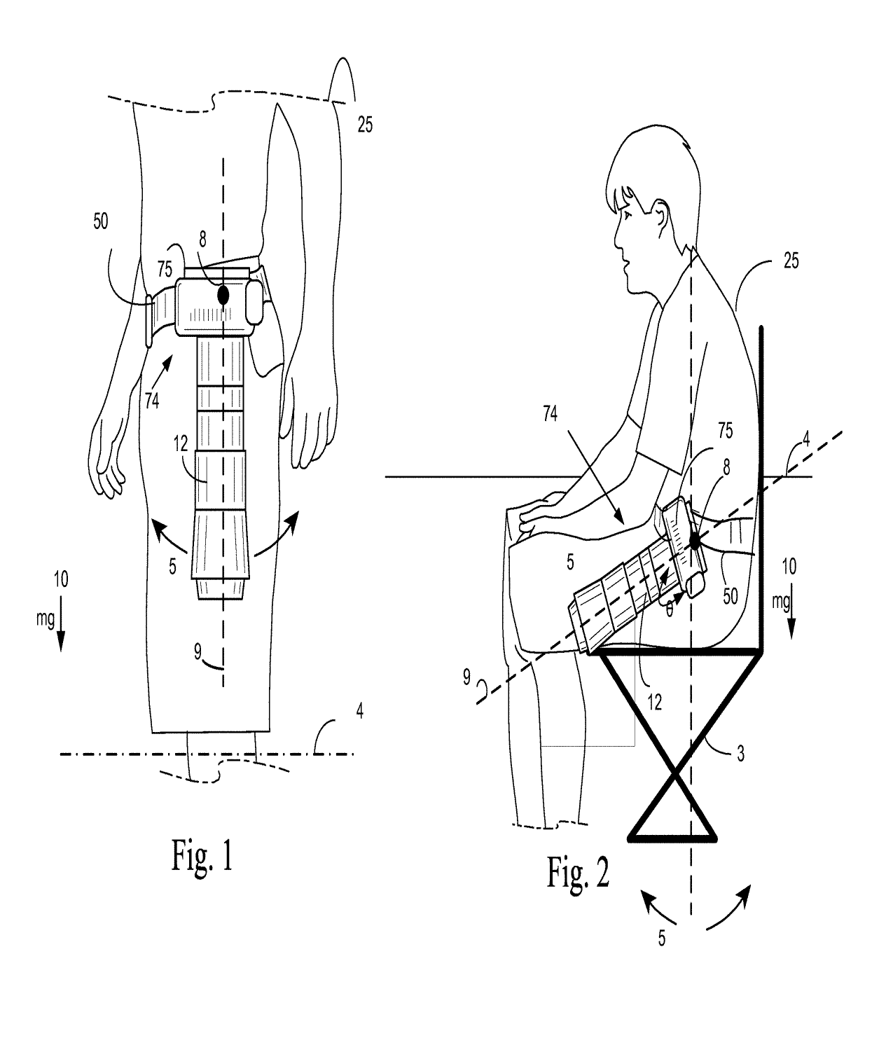

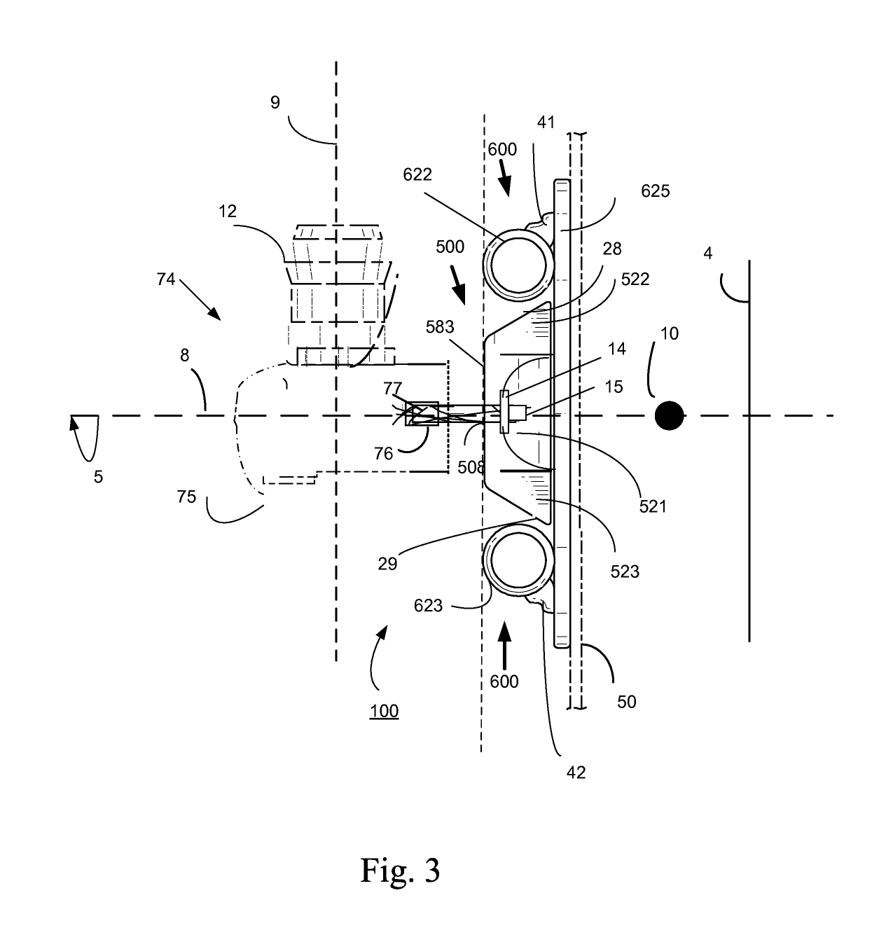

FIGS. 1 and 2 illustrate a camera and lens assembly 74 comprising a camera 75 and a lens 12 secured to a belt of a wearer by a coupling device (shown in FIGS. 3-19) according to an embodiment of the invention. Camera 75 comprises any of a wide variety of commercially available and custom made cameras. Professional as well as amateur cameras are suitable for use with the various embodiments of the present invention. It is important to note the invention is not limited in application to any particular type of camera 74. Further, the invention is useful in attaching camera 75 to belt 50 even when camera 75 is not equipped with a detachable lens 12 in a camera and lens assembly.

Photographers typically carry an assortment of portable lenses from which a particular lens 12 may be selected for attachment to a camera 75. A portable lens is typically attached to camera 75 by threaded engagement with a lens receiving portion of camera 75. When a photographer desires a different lens the photographer may detach one lens and attach a different lens. A lens 12 as illustrated in FIG. 1 is characterized by a lens housing of a generally tubular shape. However, the invention is not limited in application to any particular lens shape. The invention will find use in coupling a wide variety of cameras and camera lens assemblies to a belt 50.

FIGS. 1 and 2 illustrate a lens 12 extending from a camera 75 along a lens longitudinal axis 9. When belt wearer 25 assumes a standing posture, a coupling device (illustrated in FIGS. 3-16) according to embodiments of the invention permits assembly 74, including lens 12 to hang from belt 50 in response to gravitational force (direction indicated at 10) acting on the assembly perpendicular to the earth's surface (indicated at 4). In that posture lens longitudinal axis 9 extends parallel to a gravitational line of force 10. A coupling device of the invention permits assembly 74 to rotate about an axis 8 (axis 8 is indicated by a black dot and extends perpendicular to the plane of the drawing sheet) in response to forces other than gravity when these are exerted on the camera and lens assembly 74. For example, a coupling device of the invention permits assembly 74 to pivot about axis 8 for bidirectional movement of assembly 74 along an arc 5 responsive to force exerted by the wearer pushing the camera and lens assembly in either direction.

In that manner, coupling devices according to embodiments of the invention accommodate a variety of postures and positions of wearer 25 during a photo shoot.

### FIG. 2

For example, FIG. 2 illustrates a camera and lens assembly 74 fastened to a belt 50 of a photographer 25 seated on a bench 3. An inventive coupling device permits assembly 74 to swivel about axis 8 along arc 5 to allow the photographer to sit on bench 3 without interference that would be encountered if camera and lens assembly 74 were not capable of rotation along arc 5. Without rotation, a photographer 25 would need to detach the lens 12 from camera 75 to sit on bench 3.

As illustrated in FIG. 2 assembly 74 is shown in a rotated position with respect to line of gravitational force 10. Thus wearer 25 can move from a standing position (illustrated in FIG. 1) to a sitting position (illustrated in FIG. 2) without the need to decouple lens 12 from camera 75 and without decoupling the assembly 74 from belt 50. When wearer 25 resumes a standing position, the coupling device permits assembly 74 to swivel downward (in direction 10) in response to the force of gravity acting perpendicular to the ground 4.

### FIG. 3 Coupling Device: First Embodiment of First Coupling Part

FIG. 3 is a top view of a coupling device 100 according to one embodiment of the invention. Coupling device 100 comprises a first coupling part 500 and an opposing second coupling part 600. First coupling part 500 is shown attached to a camera and lens assembly 74 by means of a pin 44. The distal end 77 of pin 44 is threaded for engaging a receptacle 76 of camera 75. The proximal end of pin 44 is disposed through an opening 508 of first coupling part 500 for pivotal engagement with an inside surface of opening 508. In that manner camera and lens assembly 74 is pivotable about a central longitudinal axis 8 of pin 44.

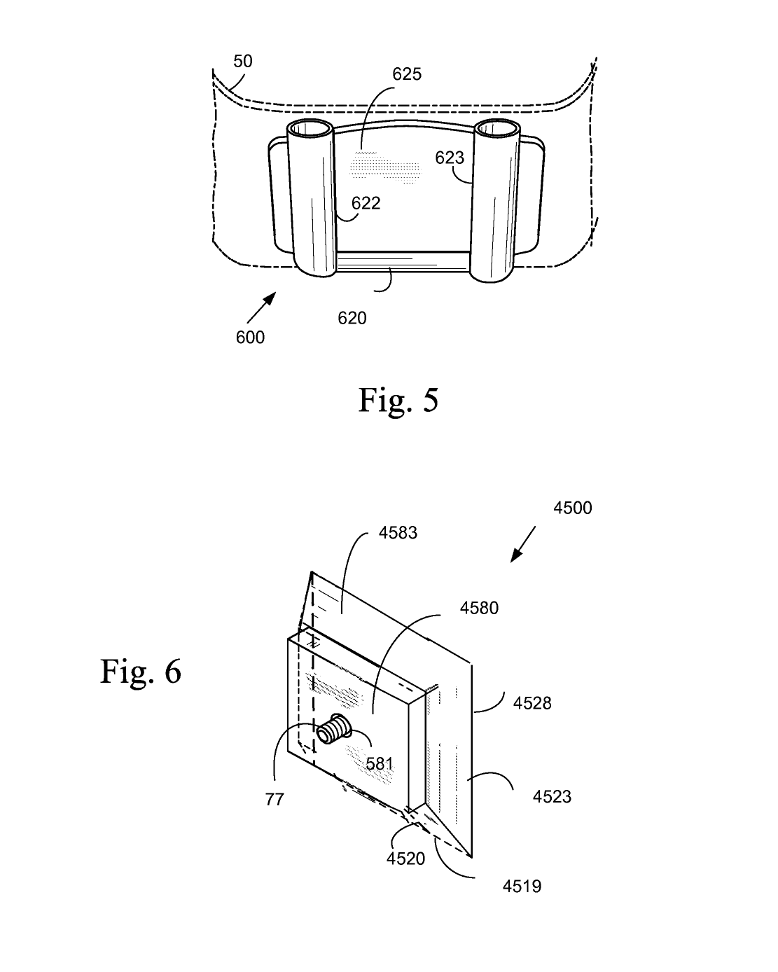

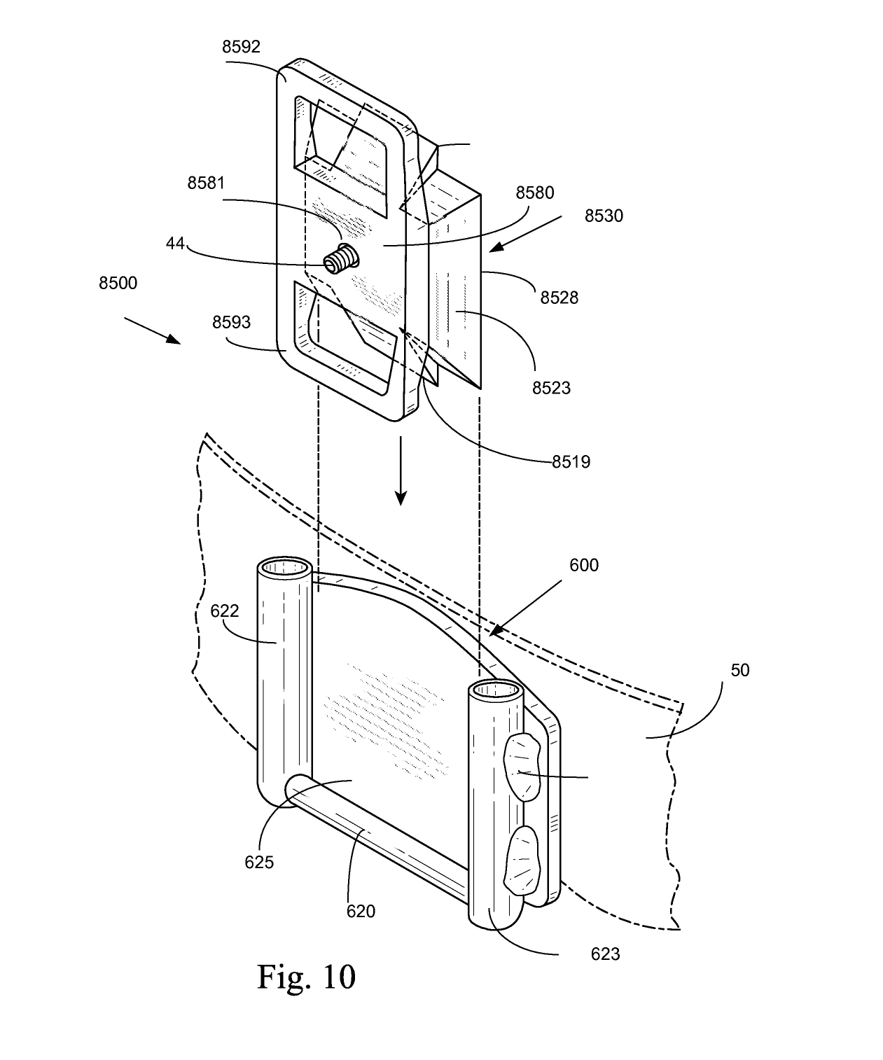

Second coupling part 600 is fixed to a belt 50. FIG. 5 is a perspective view of second part 600 according to an embodiment of the invention. Second part 600 comprises a base plate 625 having two guide members, 622 and 623 mounted thereupon. In one embodiment of the invention guide members 622 and 623 are fixed to base plate 625 by welding the guide members to the base plate. A weld suitable for mounting guides 622 and 623 to base plate 625 is illustrated in FIG. 10 at 43. Base plate 600 further comprises a slide stop flange 620 extending perpendicular to and outwardly from a plane of base plate 625. Slide stop flange 620 is disposed between guide members 622 and 623 at least partially between the lower portions of guide members 622 and 623. Slide stop flange 620 limits downward travel of a slide, for example, first part 500. Together, guide members 622 and 623 and slide stop flange 620 provide a slot for receiving first part 500.

In the embodiment of the invention illustrated in FIG. 5 guide members 623 and 624 are generally cylindrical in shape. In one embodiment of the invention guides 623 and 624 comprise hollow metallic cylinders. However the embodiment is not limited to cylindrical shapes. The invention is directed to guides 623 and 624 as configured to form slots to engage wedge portions of first part 500.

In one embodiment of the invention guides 622 and 623 are affixed to slide base plate 625 by welding. However, the invention is not limited to a particular means of affixing guides 623 and 624 to slide base plate 625. In one embodiment of the invention base plate 625 is fixed to belt 50 by, screws extending from inner surfaces of hollow guides 622 and 623, through base plate 625 and into the material of belt 50.

Returning now to FIG. 3 it is seen that first part 500 and opposing second part 600 couple camera and lens assembly 74 to a belt 50. Thus embodiments of the invention enable a wearer of belt 50 to adjust the position of camera and lens assembly 74 to accommodate bending and sitting of the wearer without obstruction or interference from the lens 12 of camera and lens assembly 74.

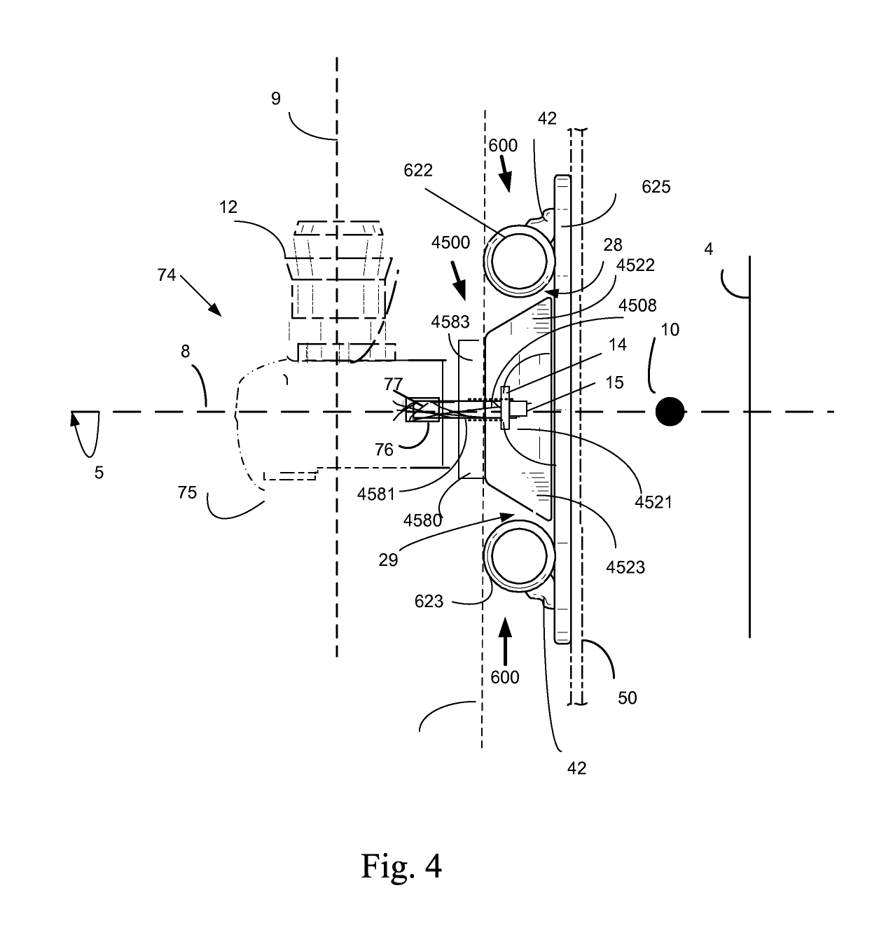

### FIGS. 4 and 6 Second Embodiment of First Coupling Device

FIG. 4 illustrates a first part 4500 of coupling device 400 according to an alternative embodiment of the invention. In the embodiment of FIG. 4, first part 4500 further comprises a slider base 4580. Slider base 4580 includes a central region defining an opening 4581 through slider base 4580. A central axis of opening 4581 is aligned with a central axis of opening 4509. FIG. 4 illustrates threaded pin 44 having an intermediate portion extending through openings 4581 and 4509. The distal end 77 of threaded pin 44 engages threads of receptacle of a camera 75. The proximal end 15 of threaded pin 44 extends through opening 4509 of second part 4500 and extends into a cavity 4521 formed on one side of first part 4500. A pin securing means, for example a nut 45 engages threads of the proximal end of threaded pin 44 so as to maintain at least a portion of proximal end 15 of threaded pin 44 within cavity 521 when coupling device 100 is assembled and in use.

Coupling device 400 further comprises a second part 600. Second part 600 is illustrated as attached to belt 50. First part 4500 is illustrated as affixed to a camera 1175. Together, second part 600 and first part 4500 secure camera 1175 to belt 1150.

FIG. 6 is a perspective view of the first coupling part 4500 illustrated in FIG. 4. A slider portion 4583 is rigidly fixed to a slider base 4580. Slider portion 4583 includes at least two laterally extending wedge portions 4522 (not visible) and 4523 extending outwardly from at least two opposite sides of a slider base portion 4580 at an angle with respect to a central longitudinal axis of pin 44. Wedge portions 4522 and 4523 form guide engaging edges 4527 (not visible) and 4528 respectively. A third wedge portion 4520 includes an edge 4519 that engages slide stop flange 620 (illustrated, e.g., in FIG. 5) to limit the sliding motion of first part 4500 with respect to second part 600 when the first and second parts are coupled together.

In the embodiment illustrated in FIG. 6 first part 4500 is generally rectangular in shape. However, the invention is not limited to rectangular shapes. Instead, a variety of shapes are suitable for forming first part 4500 and its components. For example round, oval, square, hexagonal and many other shapes are suitable for base 4580. Regardless of shape, slider base 4580 includes an opening 581 extending through a central portion of base 581.

In one embodiment of the invention the central opening 581 is of sufficient diameter to pass there-through the threaded end portion 77 of a threaded pin. The opening 581 is small enough to prevent passing there-through a head portion (not shown in FIG. 6 at the other end of the threaded pin. In that manner the threaded pin is coupled to the first part 4500 (i.e., first body portion 4500) when the first body portion is engaged with the slotted receptacle defined by base plate 625, guide members 622 and 623 and slide stop 620 of support structure 600 (illustrated in FIG. 5).

A second body portion has an opening there-through for passing the threaded end of the threaded pin such that the second body portion is coupled to the first body portion when the threaded end is engaged with the thread receiving receptacle of the camera.

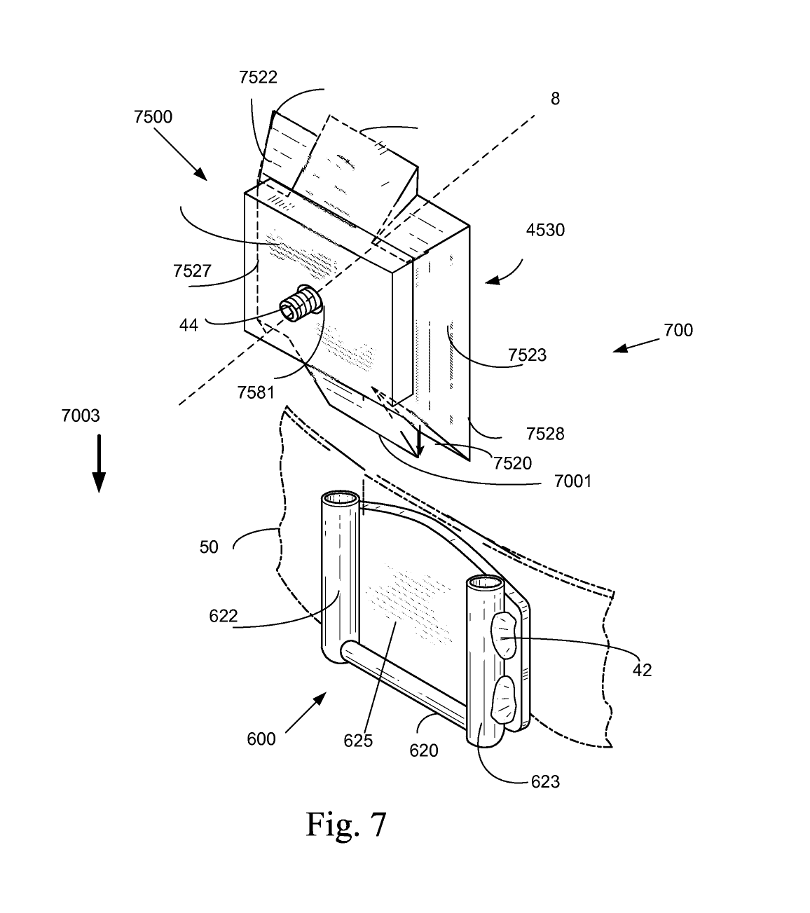

### FIGS. 7-9 Third Embodiment of First Coupling Part

FIG. 7 illustrates a coupling device (also referred to herein as a ‘holster’) 700 comprising a first part 7500 positioned for slideable engagement with an opposing second part 600. Second part 600 is similar to second part 600 illustrated previously with respect to the embodiments of FIGS. 3-6. First part 7500 differs slightly from second part 500 of previously described embodiments in that first part 7500 is formed to include a flange 7001 extending from a wedge portion 7520 of first part 7500. Flange 7001 engages slide stop flange 620 of second part 600 thereby limiting motion of first part 7500 with respect to second part 600 downwardly in the direction of arrow 7003.

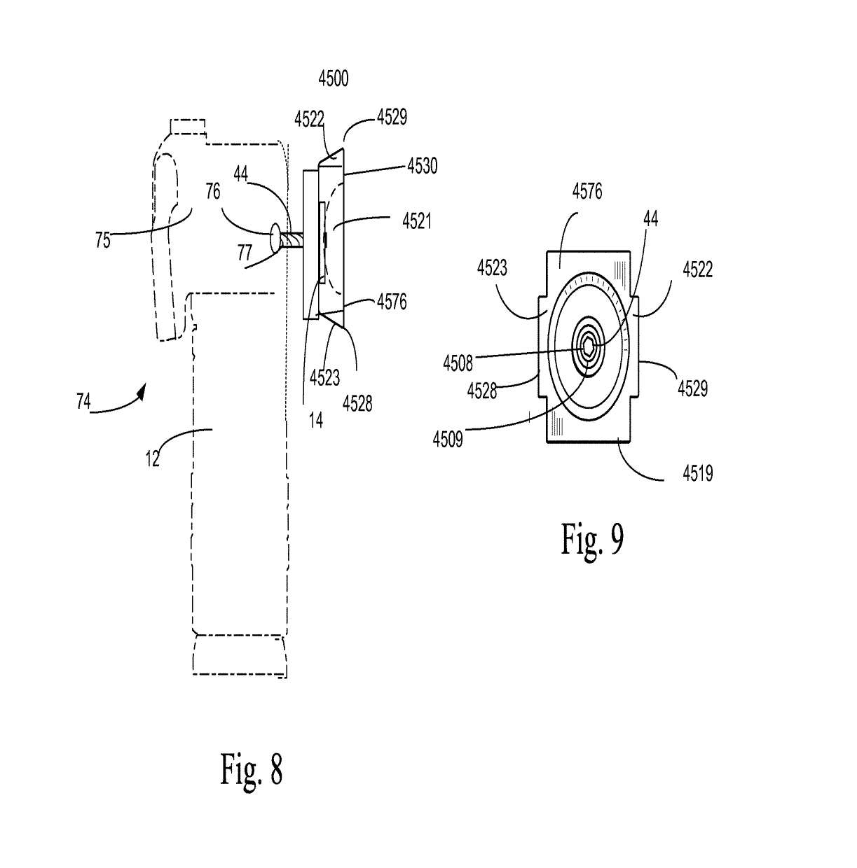

FIG. 8 is a top view of the embodiment of first part 7500 illustrated in FIG. 7 as it appears fixed to a camera and lens assembly 74. FIG. 8 further shows a side elevation view of a camera and lens assembly 74. Camera 75 includes a thread engaging receptacle 76. Many conventional cameras are equipped with a standard thread engaging receptacle 76 for use in affixing camera 75 to a tripod. The coupling device of the invention employs thread engaging receptacle 76 to secure camera 75 to a second part (illustrated for example in FIG. 3 at 500) by means of a threaded pin. (Illustrated, for example, in FIG. 3 at 44.)

FIG. 9 is a front elevation view of the embodiment of first part 7500 illustrated in FIG. 8.

### FIGS. 10-13: Fourth Embodiment of First Coupling Part

FIG. 10 is a perspective view of a coupling device 800 according to an alternative embodiment of the invention. Coupling device 800 comprises a first coupling part 8500 and an opposing second coupling part 600. Opposing second coupling part 600 for coupling device 800 is similar to the opposing parts 600 illustrated previously. First coupling part 8500 comprises a base portion 8580 including an opening 8581 in a central region of base portion 8580.

Base portion 8580 further includes rectangular extending portions 8591 and 8592. Extending portions 8591 and 8592 are generally rectangular in shape and defined by openings 8593 and 8594 respectively. Other shapes for extending portions are contemplated and the invention is not limited to embodiments wherein extending portions are rectangular. Extending portions 8591 and 8592 extend from base portion 8580 in a downwardly (in the direction of the arrow) and upwardly (in a direction opposite the direction of the arrow) respectively when first coupling part 8500 is oriented as illustrated in FIG. 10 and positioned for slideable engagement with second coupling portion 600.

FIG. 11 is a front elevation view of the first coupling part 8500 illustrated in FIG. 10 with baseplate contacting surface 8530 of slider 8583 facing the viewer. FIG. 11 illustrates the relative positions of extensions 8592 and 8591 with respect to base portion 8580.

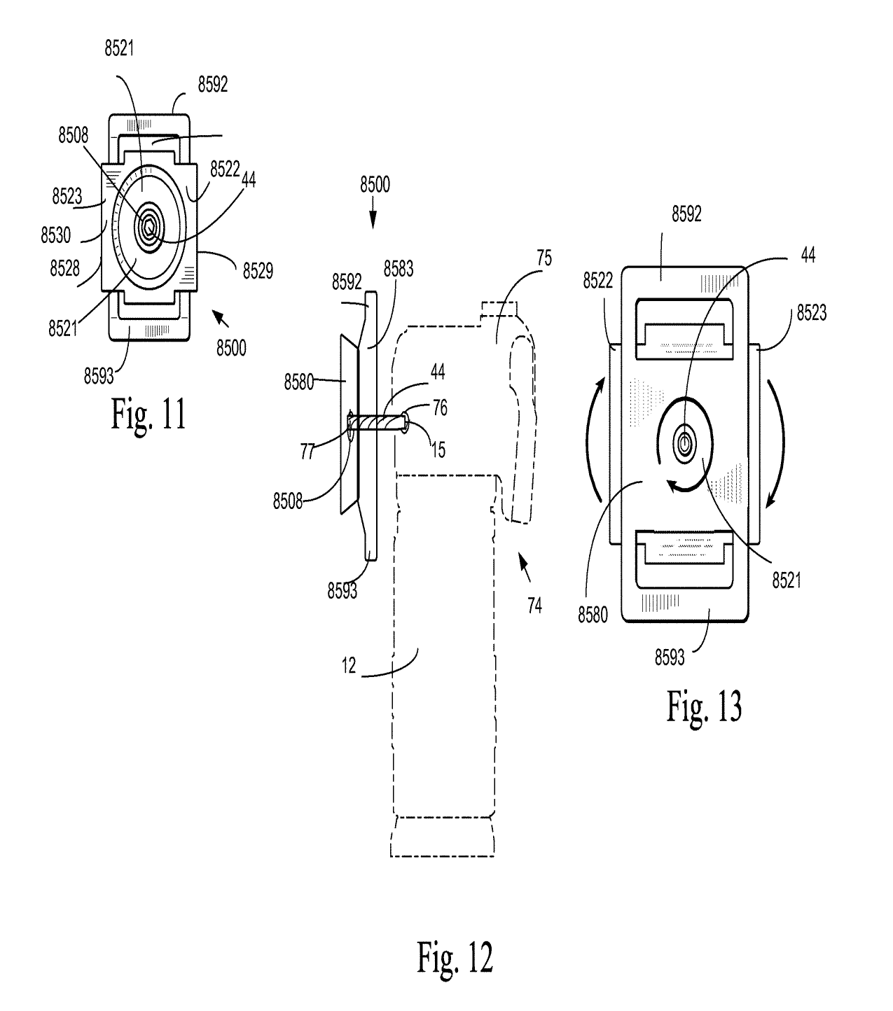

FIG. 12 is a top view of the first coupling part 8500 illustrated in FIG. 10. Pin 44 is illustrated as it appears when threadably engaged with receptacle 76 of camera 75. FIG. 13 is a front elevation view of first part 8500 as seen from the opposite side of that shown in FIG. 11. FIG. 13 illustrates rotation of first part 8500 about an axis of pin 44.

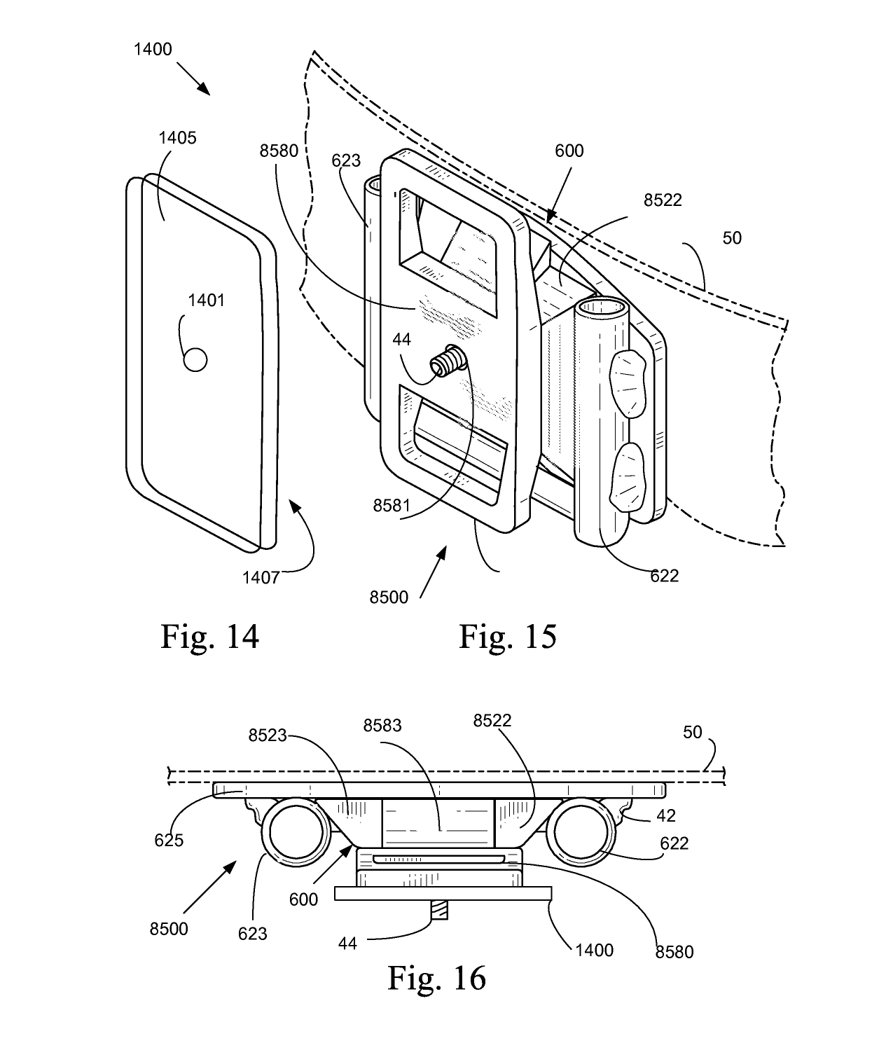

### FIGS. 14-16 Protective Barrier

FIG. 14 illustrates a camera protecting piece 1400 comprising a coupling device 1400 (illustrated in FIG. 15) according to an embodiment of the invention. FIG. 16 is a top view of coupling device 1400 of FIGS. 14 and 15 including protector 1401. Protector 1401 is interposed between based portion 8580 of first part 8500 and the housing of a camera 75 in the region of the camera's universal threaded receptacle (best illustrated in FIGS. 3 and 4). Protector 1401 acts as a protective buffer between metal portions of first part 8500 and the housing of a camera (for example camera 75 illustrated in FIGS. 1 and 2). Protector 1401 may be constructed from any type of soft, non abrasive material, for example, cloth such as felt, rubber foam materials and other non scratch or non-scuffing materials. Protector 1401 includes an opening 1401 for insertion of pin 44 prior to engaging threads of pin 44 with the threaded receptacle of a camera. Protector 1401 is generally rotatable about pin 44. Protector 1401 may or may not rotate in association with rotation of camera and lens assembly about an axis of pin 44. However, regardless of the amount of rotation of protector 1401, protector 1401 acts as a barrier preventing first part 8500 from directly contacting the housing of a camera to which first part 4500 is fixed.

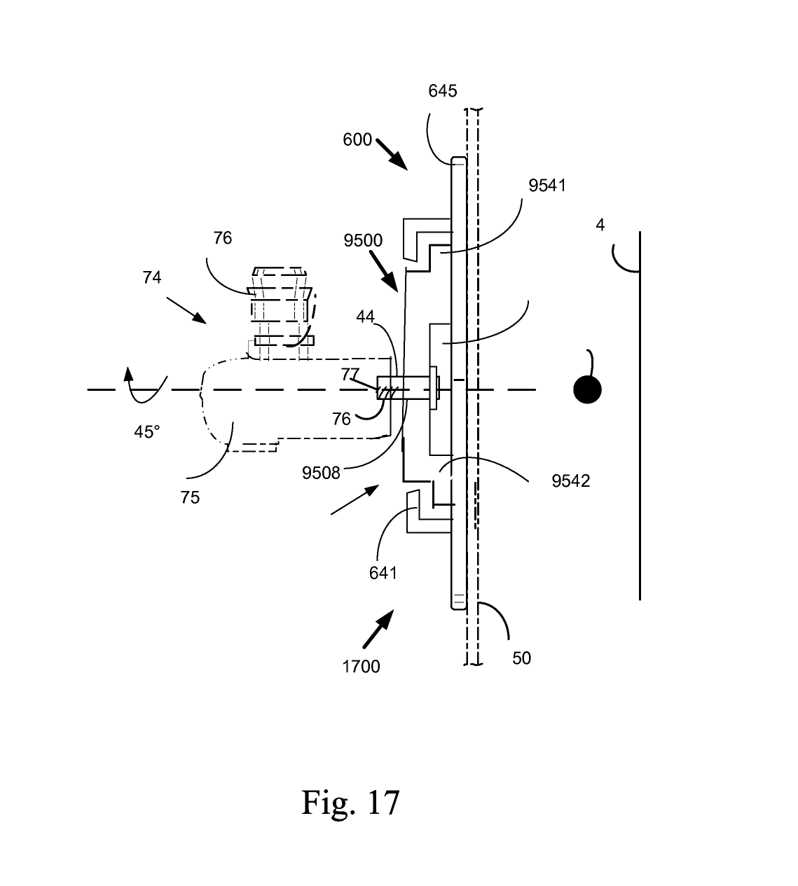

### FIG. 17 Alternative Embodiment of Coupling Device

FIG. 17 is a top view of a coupling device 1700 according to an alternative embodiment of the invention. Coupling device 1700 comprises a first coupling part 9500 and a second coupling part 9600. First coupling part 9500 is shown attached to a camera and lens assembly 74 by means of a pin 44. The distal end 77 of pin 44 is threaded for engaging a receptacle 76 of camera 75. The proximal end of pin 44 is disposed through an opening 9508 of first coupling part 9500 for pivotal engagement with an inside surface of opening 9508. In that manner camera and lens assembly 74 is pivotable about a central longitudinal axis of pin 44.

A second coupling part 9600 is fixed to a belt 50. Second part 9600 comprises a base plate 9625 having two guide members, 9622 and 9623 mounted thereupon. In one embodiment of the invention guide members 9622 and 9623 are fixed to base plate 9625 by welding the guide members to the base plate. A weld suitable for mounting guides 9622 and 9623 to base plate 9625 is illustrated in FIG. 10. Base plate 9600 further comprises a slide stop flange 9620 extending at least partially between lower portions of guide members 9622 and 9623. Slide stop flange 9620 limits downward travel of a slide, for example, first part 9500. Together, guide members 9622 and 9623 and slide stop flange 9620 provide a slot for receiving first part 9500.

An intermediate region 9519 is formed to define a cavity 9521 in coupling device 1700 when first part 9500 engages second part 9600. Flanges 9522 and 9523 are formed to permit slidable insertion of first part 9500 into slots 9642 and 9643. When inserted into slots 9642 and 9643, flanges 9522 and 9523 prevent first part 9500 from decoupling from second part 1600 by the stopping action of slot forming surface portions 9672 and 9673 of guides 9622 and 9623.

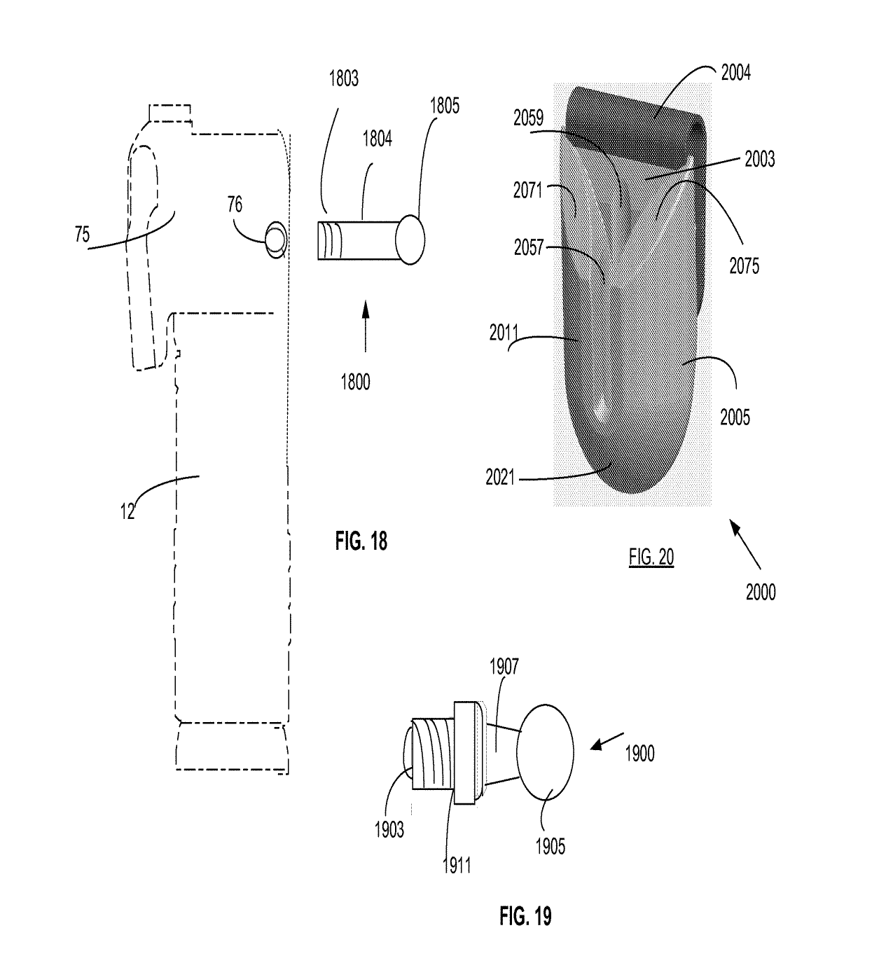

### FIG. 18

FIG. 18 illustrates a camera 75 including a thread receiving receptacle 76. A coupling device 1800 comprises a slot-engaging part 1805 for engaging a slot, for example slot 1870 illustrated in FIG. 19. A threaded pin 1804 is coupled to the slot engaging part 1805. Threads 1803 are disposed on one end portion of threaded pin 1804. Threads 1803 are configured to engage a thread receiving receptacle 76 of camera 75. In one embodiment of the invention the various components of coupling device 1800 may be constructed of steel, stainless steel, iron, or other rigid metal materials. However, alternative embodiments of the invention may employ other materials. Any rigid material capable of supporting the weight of camera 75 while coupling device is engaged in a support structure (e.g., device 2000) is suitable for comprising coupling device 1800.

The coupling device 1800 permits rotation of the camera 75 with respect to the support structure 2000 (illustrated in FIG. 20) when the thread receiving receptacle 76 of the camera 75 is engaged with threads 1803 of the threaded pin 1804 and the slot-engaging end portion 1805 is engaged with the slot 2057 (example illustrated in FIG. 20)

In one embodiment of the invention the slot engaging part 1805 of the coupling device comprises a knob. The knob may be formed as an integral part of the threaded pin. In other embodiments the knob may be formed separately and forged onto threaded pin 1804, for example by welding. In one embodiment of the invention, the knob and threaded pin comprise a coupling pin. In one embodiment of the invention, the threaded pin includes a head portion. In that embodiment the slot engaging part comprises a first body portion formed to slidably engage the slotted receptacle.

### FIG. 19

FIG. 19 illustrates an alternative embodiment 1900 of coupling device 1800. Coupling device 1900 further includes a neck portion 1907 formed between knob portion 1905 and threaded end portion 1903. A collar portion 1911 is disposed between threaded end portion 1911 and neck 1907.

### FIG. 20

FIG. 20 illustrates one example of a support structure at 2000. Support structure 2000 comprises a body portion 2021. Body portion 2021 includes front body portions 2005 and 2011 extending from a rear body portion 2003. Front body portions 2005 and 2011 define a slot 2057 for receiving knob 1805 of coupling device 1800. The support structure 2000 optionally comprises a belt clip 2004. The belt clip 2004 permits attachment of the support structure to a belt of a wearer. In one embodiment of the invention, the support structure 2000 generally provides a holster means for receiving coupling device 1800. The holster comprises a holster body 1863. The holster body has an opening 1870 in a front body portion. In some embodiments of the invention the holster includes a pressure exerting clip (not shown). The pressure exerting clip exerts pressure on a belt disposed between belt clip 2004 and holster rear body portion 2003 when the holster is attached to a belt.

### FIG. 21

FIG. 21 is a front view of a supporting structure according to an embodiment of the invention. A slot 2117 is defined by body portions 2111 and 2105 projecting from rear body portion 2303. A clip portion (not shown) may be formed on rear body portion 2103 for slidable attachment to a belt. A slot stop portion 2115 of slot 2117 is formed at an end portion 2121 of the supporting structure. Knob 1805 of coupling device 1800 engages slot 2117 and is slidable to the slide stop portion 2115. There coupling device 1800 rests allowing the supporting structure to support the weight of camera 75 through coupling device 1800.

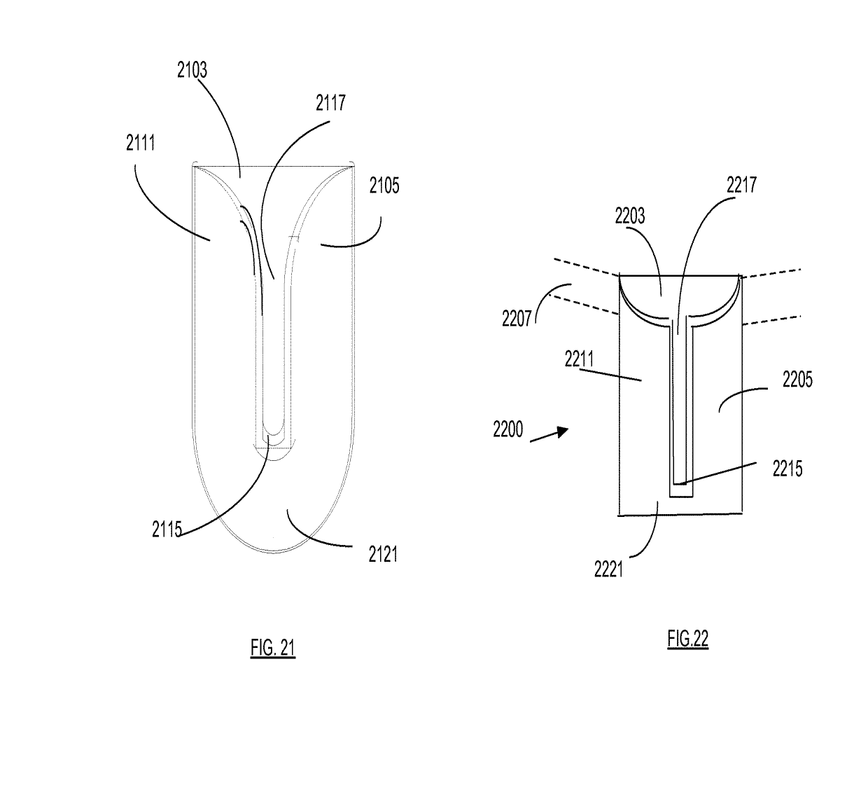

### FIG. 22

FIG. 22 illustrates another embodiment of a supporting structure 2200. Supporting structure 2200 includes a front body portion comprising body portions 2211, 2205 and 2221. Body portions 2211, 2205 and 2221 extend outwardly from rear body portion 2203 to define a slot 2217. A slot stop portion 2215 is formed at the end of slot 2217 defined by body portion 2221. Rear body portion 2203 is affixed to a belt 2207, for example, by means of a clip affixed to rear body portion 2203. Alternative embodiments of the invention include other means for affixing rear body portion 2203 to a belt 2207 such as those described herein with respect to embodiments of the invention illustrated in FIG. 10.

In order to engage coupling device pin 1800 with holster 2200, knob 1805 is disposed within slot 2217. Slot 2217 is formed to allow knob 1805 to slide through slot 2217 toward end-stop portion 2315, with threaded pin 1804 extending outwardly through slot 2217. When thread receiving receptacle 76 of camera 75 is engaged with threads 1803 of threaded pin 1804, and knob 1805 is engaged in slot 2217, camera 76 is secured to supporting structure 2200. At the same time, slot 2217 is formed to allow knob 1805 to rotate within slot 2217 without disengaging threaded pin 1804 from supporting structure 2200.

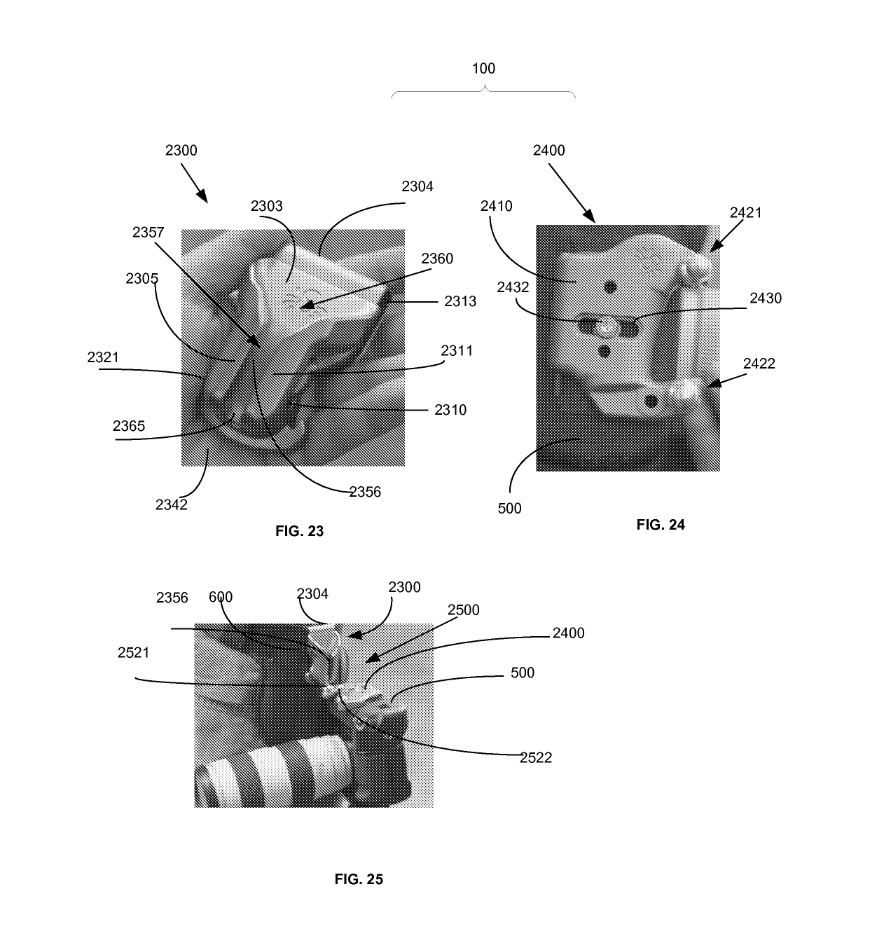

### FIG. 23 Retainer Clip Subassembly 2300

FIG. 23 illustrates another example of a support structure (also referred to herein as a retainer clip subassembly) similar to the support structure illustrated in FIG. 20 at 2000. Retainer clip subassembly 2300 comprises front body portions 2305 and 2311, side wall portions 2321, 2310 and a rear body portion 2303. Side wall portions 2321, 2310 extend outwardly in a direction away from a wearer's body and generally perpendicular to rear body portion 2303. Front body portions 2305, 2311 are formed to extend from side wall portions 2321, 2310 respectively, towards each other so as to define a channel 2356 with respect to rear body portion 2303 including a longitudinal slot 2357 accessing the channel 2356. Longitudinal slot 2357 is configured to slidably engage a neck portion of a coupling pin (coupling pin example illustrated in FIG. 25 at and in FIG. 24 at 2422 and 2420.) Longitudinal slot 2357 widens to a first opening 2360 at an upper channel end (an end nearest a wearer's head when the wearer is standing) to an extent sufficient to receive the head of the coupling pin (coupling pin comprising coupling pin neck, and coupling pin head example illustrated in FIG. 45 at 4522, 4501 and 4519 respectively).

Likewise, channel 2356 is formed to slidably engage a coupling pin head along the length of channel 2356. However, slot 2357 is sufficiently narrow to prevent the coupling pin head from escaping channel 2356 via slot 2357 at any point other than first opening 2360. In use, a coupling pin head is inserted into opening 2360 such that the coupling pin head is capable of sliding, i.e., ‘slidable’ downward through channel 2356 while the coupling pin neck slidably engages slot 2357. In that manner an item (for example base subassembly 4500 illustrated in FIG. 45) fixed to the coupling pin at an end opposite the coupling pin head is slidably coupled to retainer clip assembly 2300 by the coupling pin head slidably engaging channel 2356 while the coupling pin neck slidably engages slot 2357.

In some embodiments of the invention, channel 2356 is generally round in shape. Likewise, a coupling pin head is rounded in some embodiments of the invention. When the rounded coupling pin head is engaged in the rounded channel, a device coupled to retainer 2300 is pivotable along the longitudinal axis of slot 2357.

According to some embodiments of the invention, channel 2356 includes a second opening 2365 at a bottom channel end (channel end closest to the feet of a wearer when standing). The second opening 2365 is wide enough to allow a coupling pin neck to pass there-through yet not wide enough to allow the coupling pin head to escape the channel through the second opening. Such an advantageous configuration provides the coupling pin with an extended range of motion. When the pin head is engaged in the bottom channel end, the coupling pin is able to extend vertically downward from channel 2356 towards the ground, e.g., under the unimpeded influence of gravity. The coupling pin is also capable of swiveling in an upward and outward direction (away from the wearer's body), while the pin head is engaged in the bottom of the channel.

Retainer clip subassembly 2300 optionally comprises a belt clip 2304. The belt clip 2304 is formed to permit attachment of retainer clip subassembly 2300 to a belt worn. e.g., by a photographer, by engaging a belt within channel shaped opening 2313 of belt clip 2304.

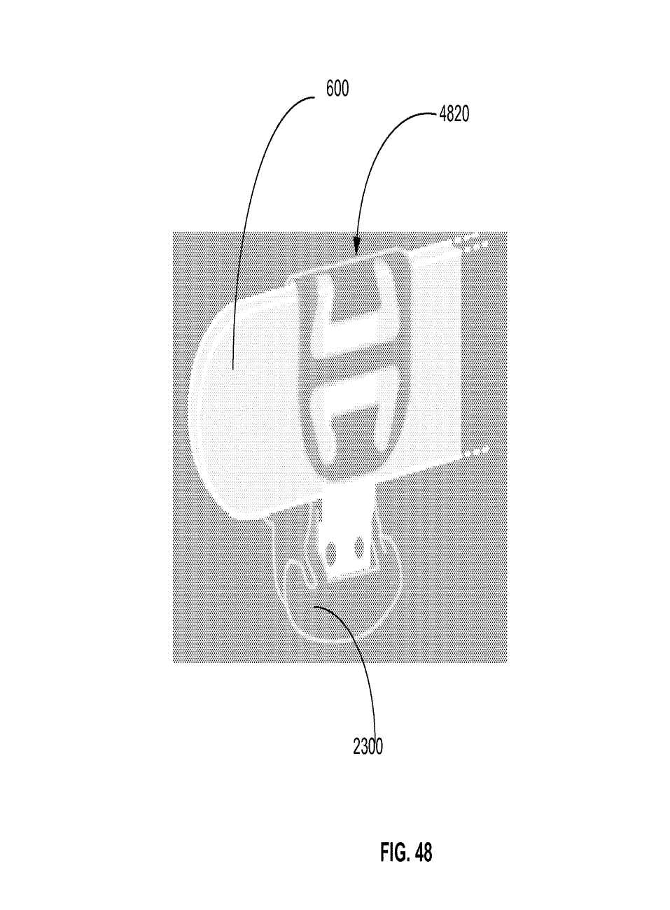

In one embodiment of the invention, retainer clip subassembly 2300 generally acts as a holster for releasably securing, e.g., a camera to a belt or other suitable article secured to a person's body. The camera is holstered in retainer clip subassembly 2300 by engaging a coupling pin of a base subassembly (example base subassembly and coupling pin illustrated in FIG. 24 at 2400 and 2420, 2422) with slot 2357. In some embodiments of the invention belt clip 2304 optionally comprises a pressure exerting clip. The pressure exerting clip exerts pressure on a belt disposed between within channel shaped opening 2313 of belt clip 2304 and a rear body portion (best illustrated in FIG. 48) of retainer clip subassembly 2300 to oppose sliding movement of retainer clip subassembly 2300 on a belt to which it is clipped.

In some embodiments of the invention rear body portion 2303 is shaped so as to provide an elongated generally rounded channel shape 2356 for receiving a generally rounded head of a coupling pin. In that case, front body portions 2305, 2311 define a generally tubular channel 2356.

### Clip 2320

One embodiment of a belt clip 2304 is illustrated in FIG. 48 at 4820. U-shaped channel 2313 (not visible in FIG. 48) enables clip 4820, and thereby retainer clip subassembly 2300 to be securely, yet releasably coupled to a photographer's belt 600, backpack or other article.

### FIG. 24

FIG. 24 depicts a base subassembly of a camera assembly according to an embodiment of the invention. Base sub assembly 300 is fixable to a housing of a camera 500. Base subassembly 300 comprises a base plate 310 and at least one removable coupling pin 320, 322. In one embodiment of the invention base sub assembly 310 includes a first coupling pin 320 spaced from a second coupling pin 322 at opposing top sides of base plate 310.

### Base Plate 310

Base plate 310 includes an elongated opening 330 along a central region of base plate 310. Elongated opening 330 is formed such that camera 500 is fixable to base plate 310 by means of a fastening pin 332. In one embodiment of the invention fastening pin 332 includes a threaded distal end (not shown) for threaded engagement with a thread receiving receptacle (not shown) of camera 500.

Camera 500 includes a thread receiving receptacle (not shown). The thread receiving receptacle is usable, for example, to affix camera 500 to auxiliary equipment such as a tripod. According to one embodiment of the invention fastening pin 332 includes a threaded distal end suitable for engaging a thread receiving receptacle of a camera to secure the camera to base plate 310. When threaded distal end of fastening pin 332 is engaged with threaded receptacle of camera 500 through elongated opening 330, base plate 310 is securely fastened to camera 500.

Camera 500 comprises any of a wide variety of commercially available and custom made cameras. Professional as well as amateur cameras are suitable for use with the various embodiments of the present invention. It is important to note the invention is not limited in application to any particular type of camera 500.

### Coupling Pins

As illustrated in FIG. 6, each coupling pin 320, 322 is formed to include a ball portion 331, a neck portion 333 and a pin base portion 335. Ball portion 331 is formed for slidable insertion into tubular channel 256 via opening 260. Neck portion 333 of coupling pin 320 extends through slot 258 of retainer 250. Ball portion 331 is rotatable within tubular channel 256 so as to permit rotation of camera 500 about an axis of neck portion 333 when coupling pin 320, 322, is positioned to couple base assembly 300 with retainer 240.

### FIG. 25

FIG. 25 depicts a holster assembly 2500 including a retainer and clip subassembly 2300 engaging a base subassembly 2400 via a coupling pin 2521 according to an embodiment of the invention. A camera 500 is fastened to base subassembly 2400. In one embodiment of the invention, camera 500 is fastened to base subassembly 2400 by means of a standard threaded bolt (e.g., 2432 illustrated in FIG. 24) of a type commonly used to affix a camera to a camera stand. In the embodiment illustrated, holster 2500 securely couples camera 500 to a belt 600 of a photographer. At the same time, the photographer is enabled to grasp camera 500 and quickly disengage it from retainer 2300 when needed.

As shown in FIG. 25, retainer clip subassembly 2300 is attached via clip 2304 to a belt 600 or other article worn by a photographer. In the camera carrying position illustrated in FIG. 25, a coupling pin 2521 extends downwardly and outwardly (away from the body) through the second opening of channel 2356 (as illustrated in FIG. 23). As seen in FIG. 25, camera carrying assembly 2500 enables a photographer to conveniently carry camera 500 within easy grasp. At the same time, camera 500 is quickly and easily detachable from retainer 2300.

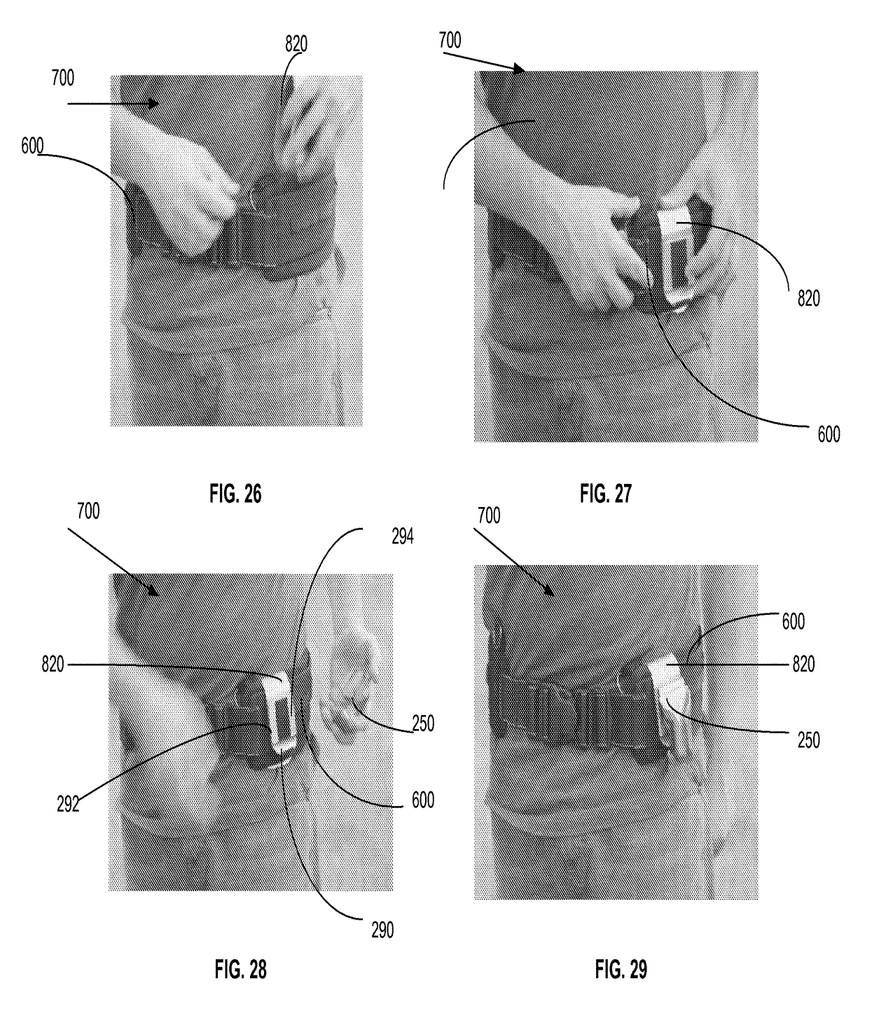

### FIG. 26-27

FIGS. 26 and 27 depict an auxiliary clip 820 for use with a holster assembly according to an embodiment of the invention. In some cases the thickness of a photographer's belt 600 exceeds the capacity of u-shaped channel 213. In that case, some embodiments of the invention include an auxiliary clip 820. FIGS. 26-27 depict engagement of auxiliary clip 820 of with a belt 600 of a photographer 700. FIG. 26 depicts a photographer orienting clip 820 with respect to belt 600 in preparation for secure engagement of clip 820 to belt 600. FIG. 27 depicts a photographer 700 in the act of engaging clip 820 with belt 600.

### FIG. 28-29

FIG. 28 depicts a retainer and clip subassembly of an embodiment of the invention positioned ready for engagement with the auxiliary clip illustrated in FIGS. 26 and 27. FIG. 29 depicts engagement of the retainer and clip subassembly 250 of a holster comprising a camera carrying assembly coupled to a belt 600 with auxiliary clip 820. FIG. 28 depicts a photographer grasping carrying assembly 100 in preparation for coupling to auxiliary clip 820. FIG. 28 illustrates an embodiment of a clip 820 including first and second clip guides 292, 294 and a bottom lip 290. Clip 820 is attached to a belt 600 of a wearer by slidably engaging clip 820 with belt 600 as illustrated in FIGS. 26 and 27.

In FIG. 29, Clip 820 engages retainer 250 via clip guides 292, 294 (FIG. 28). A bottom lip 290 provides a stop which functions to preventing escape of camera retainer 250 from clip 820, e.g., escape by sliding downwardly through clip guides 292, 294.

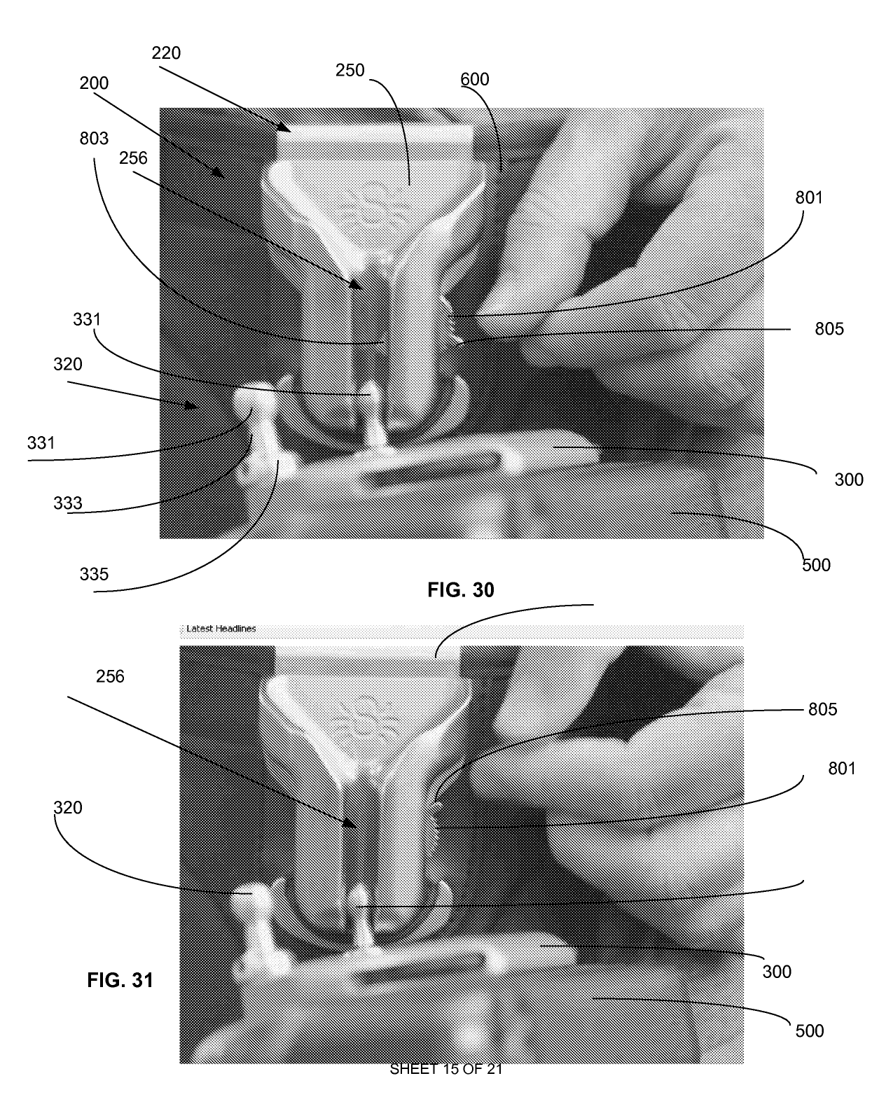

### FIG. 30

FIG. 30 depicts a retainer and clip subassembly coupled to a base subassembly via a coupling pin according to an embodiment of the invention, the embodiment including a thumbwheel latch in a latched position. FIG. 30 depicts a retainer 250 of retainer clip assembly 200 according to an embodiment of the invention including a thumbwheel latch mechanism 800 in a latched position. Thumbwheel latch mechanism 800 comprises a manually operable thumbwheel portion 801 and a lock portion 803. Lock portion 803 can take one of two positions, depending on manual operation of thumbwheel portion 802. In a first position, for example, with lever 805 of thumbwheel portion 801 in a downward position, lock portion 803 extends into generally circular channel 256 of retainer 250. In that position, lock portion 803 prevents decoupling of camera 500 from retainer 250 by stopping upward movement of coupling pin 320 within generally circular channel 256.

### FIG. 31

FIG. 31 depicts a retainer and clip assembly engaged coupled to a base assembly via a coupling pin according to one embodiment of the invention, wherein a thumbwheel latch is shown in an unlatched position. FIG. 31 depicts a retainer 250 as described above, with thumbwheel portion 802 shown in a second position, i.e., an unlatched position. In an unlatched position, lever 805 is positioned in an upward position with respect to a ground plane. With lever 805 in an upward position, lock portion 803 is maintained outside of channel 256. In that position, coupling pin 320 is not prevented from movement through channel 256. Therefore, the second position enables camera 500 to be easily decoupled from retainer clip subassembly 200.

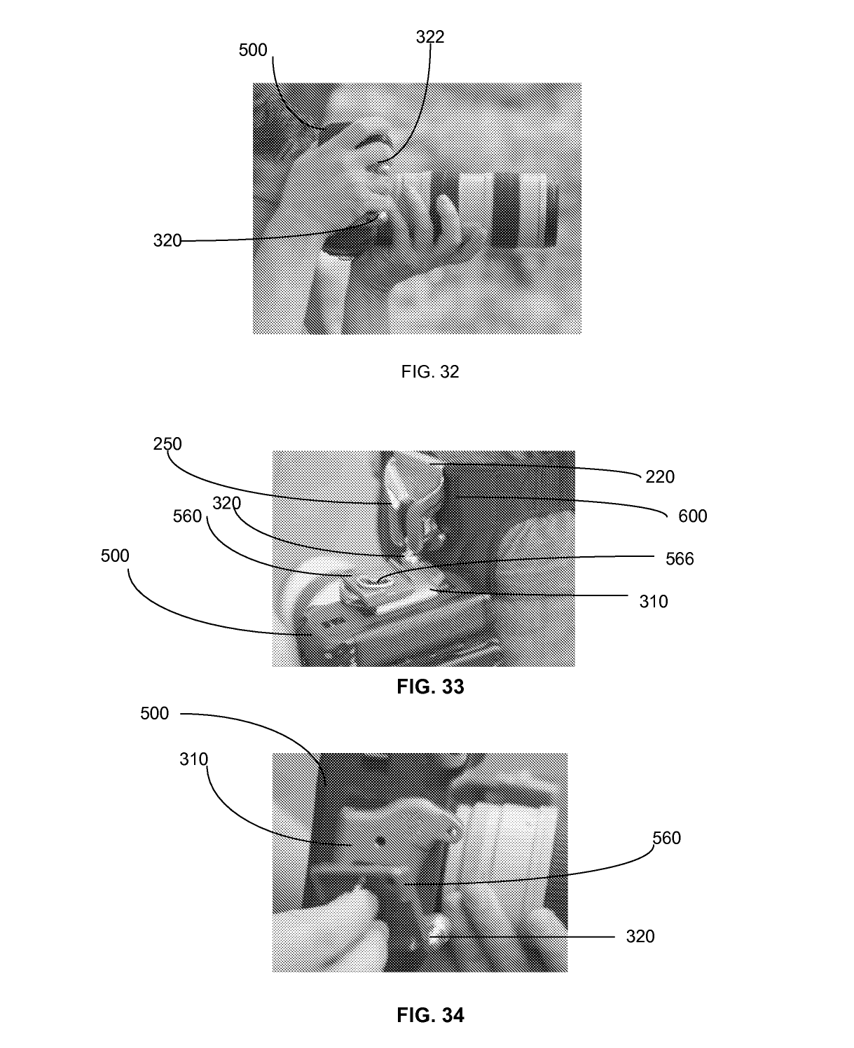

### FIG. 32

FIG. 32 illustrates a user's hands engaging first and second coupling pins of a base assembly of a camera carrying assembly according to an embodiment of the invention. FIG. 32 illustrates coupling pins 320, 322 spaced from each other on base subassembly 300. Advantageously, coupling pins 320, 322 enable photographer 700 to securely grasp camera 500 by engaging coupling pins 320, 322 between the photographer's fingers.

### FIG. 33

FIG. 33 illustrates a camera carrying assembly according to an embodiment of the invention including a coupling plate. FIG. 33 illustrates a camera carrying assembly 100 according to an embodiment of the invention further including a coupling plate 560. Coupling plate 560 enables coupling of a camera 500 to an auxiliary device such as a tripod, while camera 500 is affixed to base subassembly 300. According to one embodiment of the invention, coupling plate 560 is securable to base subassembly 300 by means of a locking pin 566.

### FIG. 34

FIG. 34 illustrates a camera carrying assembly according to an embodiment of the invention including a coupling plate and illustrating attachment of the coupling plate to the base of the camera carrying assembly. FIG. 34 illustrates a camera carrying assembly according to an embodiment of the invention including a coupling plate 560 and illustrating attachment of the coupling plate 560 to base subassembly 300.

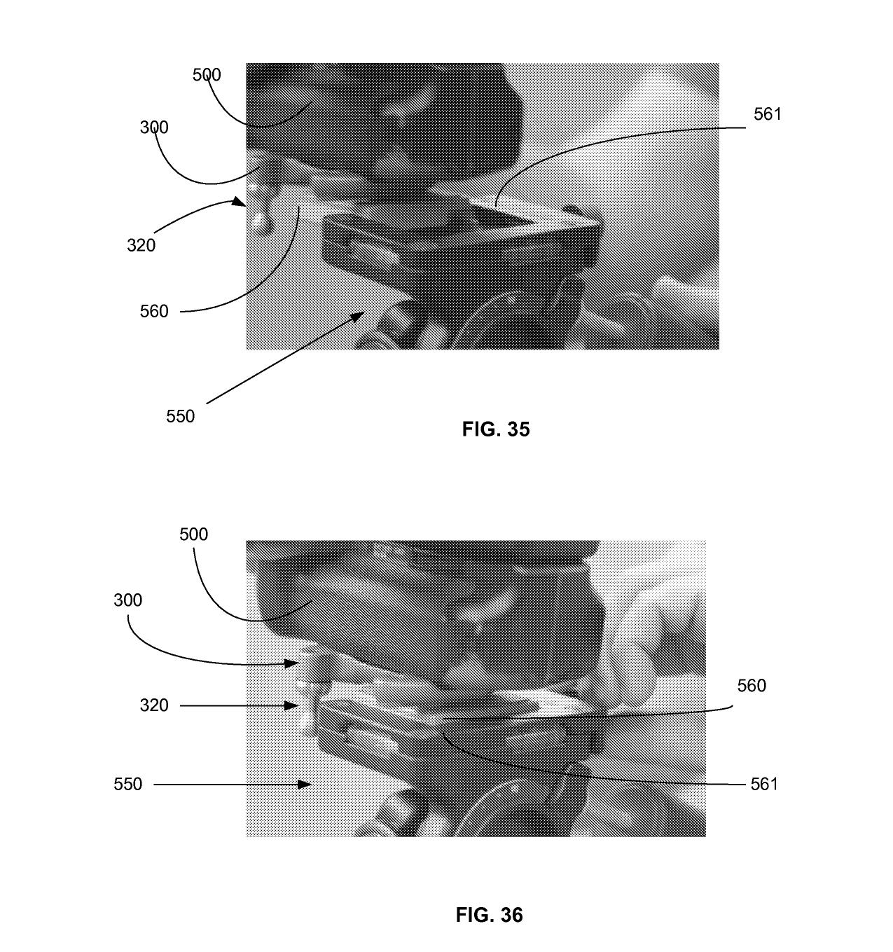

### FIG. 35-36

FIG. 35 illustrates the coupling plate of FIG. 10 engaging a coupling plate receptacle of a tripod according to an embodiment of the invention. FIGS. 35-36, illustrate the coupling plate 560 of FIG. 10 engaging a coupling plate receptacle of an auxiliary device 550, e.g., a tripod.

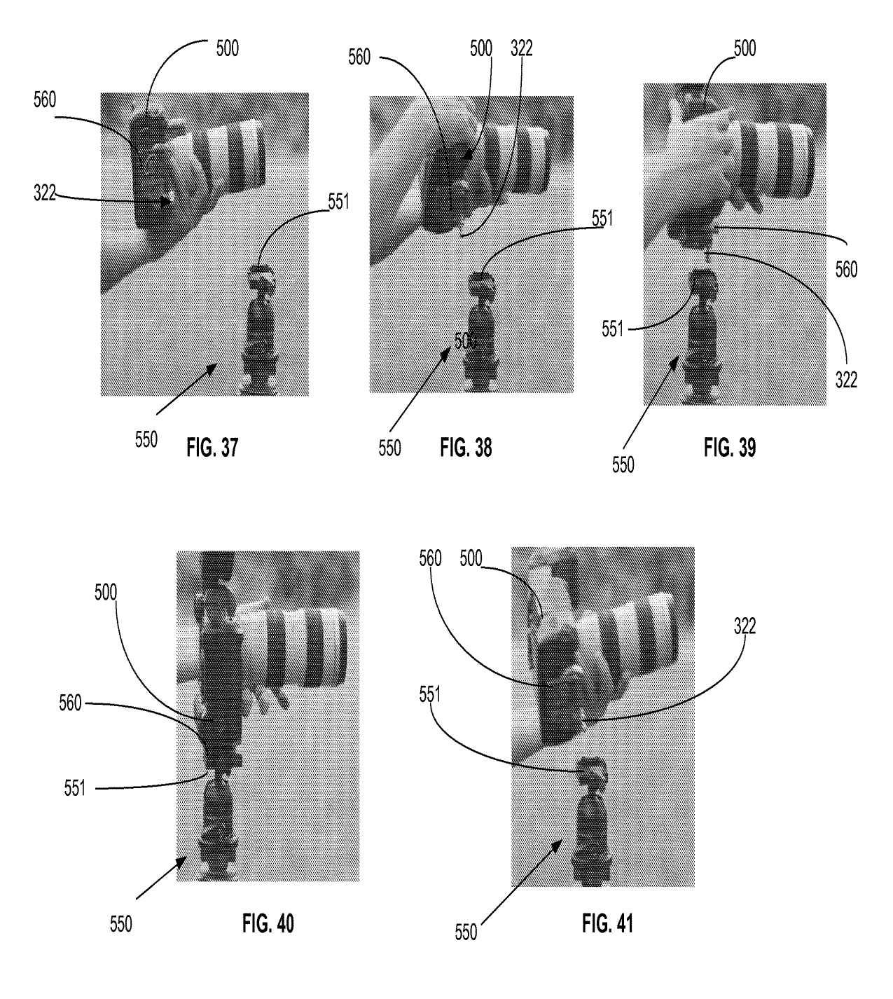

### FIG. 37-41

FIGS. 37-41 illustrate steps for coupling a camera to a tripod by means of a coupling plate and coupling plate receptacle 561 according to an embodiment of the invention.

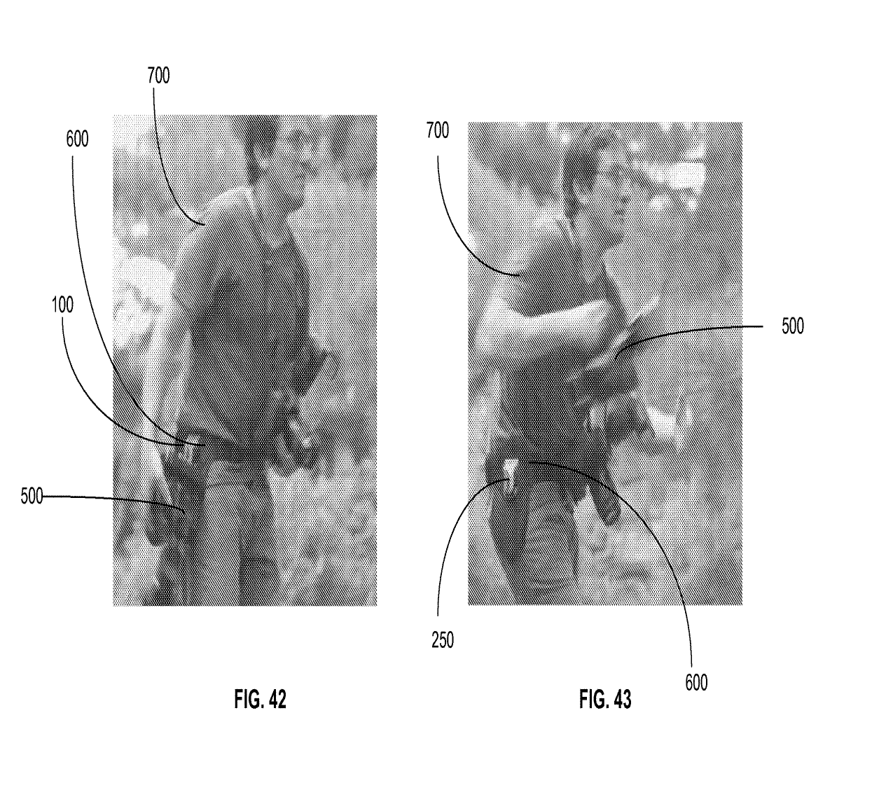

### FIG. 42-43

FIGS. 42-43 illustrate a photographer engaging and disengaging a camera from the photographer's belt using a camera carrying assembly according to an embodiment of the invention. Photographers frequently must switch from one camera to another during a shoot. Therefore, the ability to carry quickly and easily detach a stowed camera is important. FIG. 42 illustrates a camera 500 coupled to a belt 600 of a photographer 700 via coupling device 100. As illustrated in FIG. 42, photographer 700 grasps camera 500 in order to disengage camera 500 from belt 600. FIG. 43 illustrates a photographer in the action of disengaging a camera 500 from retainer and clip subassembly 200, and therefore from the photographer's belt 600 according to an embodiment of the invention.

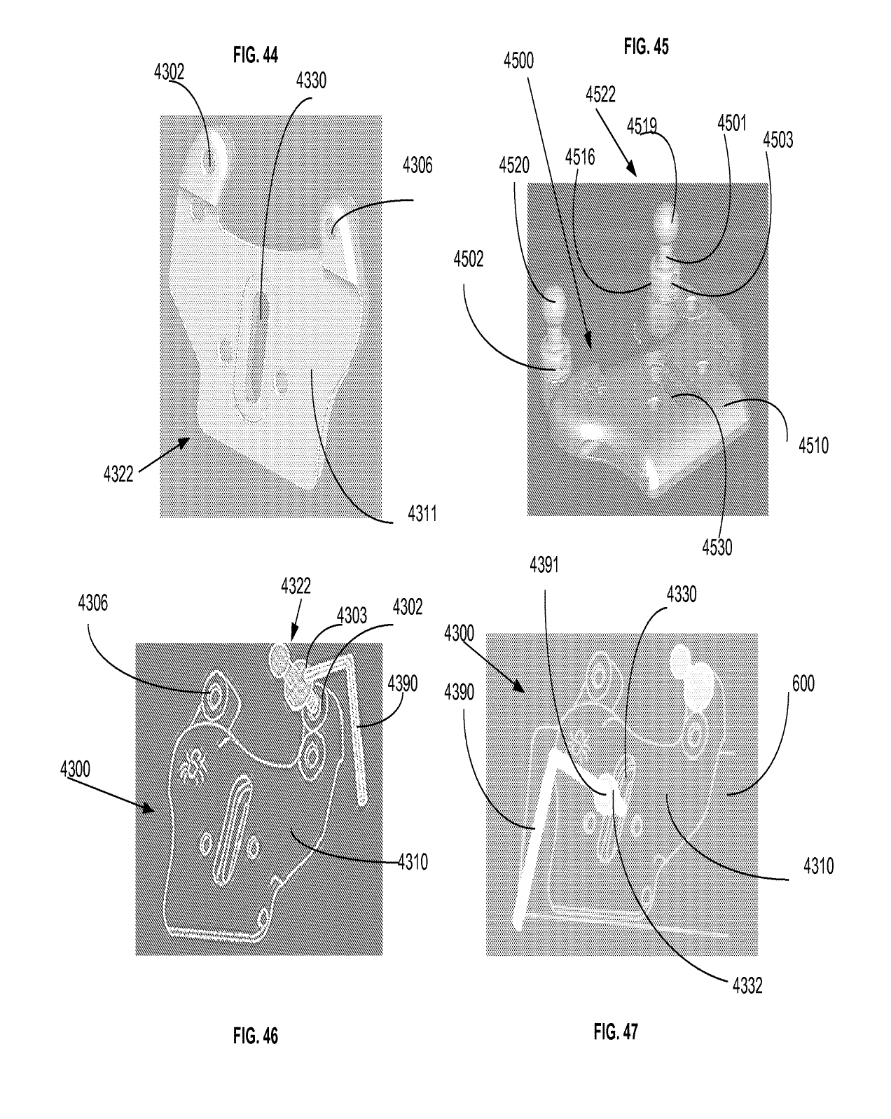

### FIG. 44

Figure illustrates a rear surface 311 of a base plate of a base subassembly 322 (Also illustrated in FIG. 24 at 2400) of a holster assembly according to an embodiment of the invention. Base subassembly 322 includes a central longitudinal slot 330 for passing a standard threaded bolt there-though (as illustrated in FIG. 47). In that manner a camera can be securely affixed to base subassembly 322.

### FIG. 45

FIG. 45 illustrates a base subassembly 4500 of a camera carrying assembly according to an embodiment of the invention. Base subassembly 4500 comprises base plate 4310 and at least one coupling pin 4320, 4322. An example coupling pin 4322 comprises ball portion 4319, neck portion 4318 and nut 4316. In one embodiment of the invention, at least one opening 4303 is formed in nut 4316 to receive an end of an attaching tool. According to one embodiment of the invention base subassembly 4300 includes two receptacles configured to receive coupling pins. Therefore, the invention enables a photographer to carry camera 500 on either his right or left side. For example, to carry camera 500 on a photographer's right side, coupling pin 4320 is coupled to an upper right opening (FIG. 46 at 4302) of base plate 4310. To carry camera 500 on a photographer's left side, coupling pin 4320 is coupled to an upper left opening (FIG. 46 at 4306) of base plate 4310.

### FIG. 46

FIG. 46 illustrates a base subassembly 4300 of a camera carrying assembly 100 according to an embodiment of the invention including an attaching tool 4390. In one embodiment of the invention an attaching tool, e.g., a wrench 4390 is provided. In one embodiment of the invention wrench 4390 is disposed inside base 4310 and is removable and replaceable by a photographer. To attach base 4310 to a housing of camera 500, the photographer engages a threaded end of coupling pin 4320 into thread receiving receptacle 4302. To more tightly fasten coupling pin 4320 to base 4310, the user inserts wrench 4390 into opening 4303 of coupling pin 4322 and turns the wrench.

### FIG. 47

FIG. 47 illustrates a base subassembly 4300 of a camera carrying assembly 100 according to an embodiment of the invention including an attaching tool 4390. In FIG. 47 wrench 4390 is inserted into a corresponding opening 4391 of pin 4332. Use of wrench 4390 enables a photographer to easily engage pin 4332 with a thread receiving receptacle provided on housing of camera 500.

### FIG. 48

FIG. 48 illustrates a belt 600 threaded through a clip 220 of a retainer and clip subassembly 200 of a camera carrying assembly 100 according to an embodiment of the invention. In this embodiment a photographer fastens his belt 600 to clip 220 by threading belt 600 between clip 220 and retainer 250.

### Construction Materials

There has thus been provided a camera carrying assembly. Camera carrying assembly 100 may be constructed of any metal having sufficient strength for bearing the weight of camera equipment. Various embodiments of the invention may be constructed, in whole or in part using, for example, steel, aluminum, or other metallic materials. Alternatively, camera carrying assembly may be constructed wholly or in part of plastic or other non metallic materials.

Thus there have been provided new and improved methods and systems for carrying camera and lens assemblies on a belt of a wearer. While the invention has been shown and described with respect to particular embodiments, it is not thus limited. Numerous modifications, changes and enhancements will now be apparent to the reader.

1. A coupling device comprising:
a slot-engaging part for engaging a slotted receptacle of a support structure;
a threaded pin coupled to the slot engaging part, the threads configured to engage a thread receiving receptacle of a camera;
the coupling device configured to permit the camera and lens assembly to swivel about an axis of the camera lens for bidirectional movement of the camera and lens assembly with respect to the support structure in response to gravity and any force exerted by a user pushing the camera and lens assembly in any direction, when the thread receiving receptacle of the camera is engaged with threads of the threaded pin and the slot-engaging end portion is engaged with the slotted receptacle.

2. The coupling device of claim 1 further comprising a support structure, and wherein the support structure comprises a clip, and wherein the clip comprises:
a first side defining the slotted receptacle, and a second side permitting attachment of the clip to a belt of a wearer.

3. The coupling device of claim 1 wherein the support structure comprises a holster and the holster comprises:
a holster body having an opening in a front body portion defining the slotted receptacle; and
a holster rear body portion for supporting an attaching clip, the attaching clip for attaching the holster to a belt of a wearer.

4. The coupling device of claim 1 wherein the slot engaging part comprises a knob and the knob is formed as an integral part of the threaded pin.

5. The coupling device of claim 1 wherein the knob and threaded pin comprise a coupling pin.

6. The coupling device of claim 1 wherein the threaded pin includes a head portion and wherein the slot engaging part comprises:
a first body portion formed to slidably engage the slotted receptacle, the first body portion defining a central opening of sufficient diameter to pass therethrough the threaded end portion of the threaded pin, the opening small enough to prevent passing there-through the head portion, such that the threaded pin is coupled to the first body portion when the first body portion is engaged with the slotted receptacle;
a second body portion having an opening there-through for passing the threaded end of the threaded pin such that the second body portion is coupled to the first body portion when the threaded end is engaged with the thread receiving receptacle of the camera.

7. A coupling piece comprising:
a slot engaging portion on one end for engaging a slotted receptacle of a camera supporting structure;
a camera engaging portion on another end for engaging a thread receiving receptacle of a camera;
the coupling piece configured to permit rotation of the camera with respect to the supporting structure when the camera is engaged with the coupling piece and the coupling piece is engaged with the slotted receptacle of the supporting structure.
